(19) United States
(12) Patent Application Publication
(10) Pub. No.: US 2022/0374568 A1
(43) Pub. Date: Nov. 24, 2022

(54) Simulation of a Battery

(71) Applicant: TWAICE Technologies GmbH, München (DE)

(72) Inventor: Michael Baumann, München (DE)

(21) Appl. No.: 17/633,398

(22) PCT Filed: Aug. 7, 2020
(86) PCT No.: PCT/DE2020/100695

§ 371 Date: Feb. 7, 2022

(30) Foreign Application Priority Data
Aug. 8, 2019 (DE) 10 2019 121 461.0

(51) Int. Cl. G06F 30/23

(52) U.S. Cl. CPC G06F 30/23; G06F 2119/08

(57) ABSTRACT

The invention relates to general technology for monitoring the state of a battery, e.g., a lithium-ion battery. A thermal simulation model is used for this purpose. Different examples relate to the parameterizing of the thermal simulation model.

### TECHNICAL FIELD

Various examples of the invention relate to the simulation of a battery. Various examples relate particularly to the parameterizing of a simulation model.

### BACKGROUND

Thermal and electrical simulation models are known for the simulation of a battery. It is often complicated and problematic to determine the correct simulation model or the correct combination of simulation models for the precise description of the electrical and thermal behavior of the battery. In addition, it is oftentimes difficult to set (parameterization) the parameter values of such simulation models according to the actual properties of the battery. In this case however, accurate parameterization is helpful for obtaining precise results from the simulation.

### BRIEF DESCRIPTION OF THE INVENTION

Therefore, there is a need for improved techniques regarding the simulation of a battery. In particular, there is a need for improved techniques regarding the parameterization of simulation models.

This object is achieved by means of the features of the independent claims. The features of the dependent claims define embodiments.

A computer-implemented method for time-discrete simulation of a battery comprises the application of a thermal model in order to obtain a time-discrete temperature characteristic of the battery. The thermal model comprises the following in this case: a thermal cell model for cells of the battery, an air model for heat exchange between the cells of the battery and ambient air, as well as additionally a thermal system model for heat exchange between the cells of the battery and a respective environment. When the thermal model is used for a time-step, a cell temperature of the cells of the battery is determined by means of the thermal cell model as a function of an air temperature of the ambient air obtained from the air model in a previous time-step and, in addition, as a function of an ambient heat flow obtained from the thermal system model in the preceding time-step. When the thermal model is used for the time-step, the air temperature of the air model and the ambient heat flow of the thermal model are determined as a function of the cell temperature of the cells.

Thus, there is an alternating determination of cell temperature, on the one hand, and the air temperature and the ambient temperature, on the other hand. This iterative method is continued for several time-steps.

In this case, the thermal model can be combined with an electrical model in various examples. In this manner, a thermal-electrical co-simulation can take place. For example, the development of temperature or of electrical state variables of the battery could be determined respectively for a time-step in an alternating manner.

In addition, the simulation (which may comprise the thermal model and the electrical model) can be associated with an aging prediction. For example, the reduction in capacity could be predicted. The aging model can be executed linked to the simulation. This also means that the corresponding aging can be predicted for each time-step.

It is also possible, by means of the computer-implemented method, to characterize the state of the battery especially precisely.

In some examples, it would be possible to use such a characterization of the state of the battery to suitably set the further operation of the battery. This could prevent, for example, an especially rapid reduction in the capacity of the battery.

The simulation can be implemented in this case for a plurality of batteries. In particular, it would be possible for the simulation to be carried out for a plurality of battery types. The simulation is correspondingly parameterized to be able to consider different properties of different battery types or batteries.

According to the examples described herein, various model parameters of the simulation can be parameterized specific to the type. This means that a different parameterization can be used for different battery types.

In some examples, it would also be possible for the parameterization to take place specific to the battery. In other words, this means that different parameter values for the models can be used for different batteries of the same type. In this manner, for example, different types of installation of the battery, different cooling designs, different load profiles, etc. can be considered within the context of the simulation.

The simulation can be repeated. This means that the simulation can be triggered respectively at several points in time. This provides for repeated state monitoring of the state of the battery. In some examples, it would be possible for the parameterization to be implemented once, e.g., upon registering the corresponding battery type or the corresponding battery in a database. In another example, it would also be possible, however, for the parameterization to be implemented repeatedly. This means that different parameter values for the models of the simulation can be determined for one and the same battery repeatedly. In this manner, it would be possible, for example, to consider different, time-variable boundary operating conditions (e.g., activated/deactivated active cooling, different load profiles, etc.) dynamically by means of the simulation.

The previously shown features and features to be described in the following can be used not only in the corresponding explicitly shown combinations but also in further combinations or in isolation, without going beyond the protective scope of the present invention.

### BRIEF DESCRIPTION OF THE FIGURES

FIG. 1 schematically illustrates a system comprising several batteries and a server according to various examples.

FIG. 2 schematically illustrates details associated with the batteries according to various examples.

FIG. 3 schematically illustrates details associated with the server according to various examples.

FIG. 4 is a flowchart of an exemplary method according to various examples.

FIG. 5 schematically illustrates the use of a simulation of cells of the battery associated with the aging modeling of a battery according to various examples.

FIG. 6 schematically illustrates an electrical-thermal simulation of the cells of the battery as well as the use of an aging model.

FIG. 7 is a flowchart according to various examples, which illustrates the use of an electrical simulation model as well as a thermal simulation model.

FIG. 8 illustrates details associated with the thermal simulation model from FIG. 7.

FIG. 9 is a flowchart according to various examples, which illustrates details associated with the parameterization of the thermal simulation model.

FIG. 10 illustrates an electrical simulation model according to various examples.

FIG. 11 is a flowchart according to various examples, which illustrates details associated with the parameterization of the electrical simulation model.

### DETAILED DESCRIPTION OF EMBODIMENTS

The previously described properties, features, and advantages of this invention as well as the type and manner as to how they are achieved will become more clearly and noticeably understandable in the context of the following description of the exemplary embodiments, which are explained in greater detail in connection with the drawings.

In the following, the present invention is explained in greater detail by means of preferred embodiments, with reference to the drawings. The same reference numerals refer to equivalent or similar elements in the figures. The figures are schematic representations of various embodiments of the invention. Elements shown in the figures are not necessarily shown to scale. Rather, the various elements shown in the figures are reflected such that their function and general purpose will be understandable to one skilled in the art. Connections and couplings between functional units and elements shown in the figures can also be implemented as a direct connection or coupling. A connection or coupling may be implemented wired or wirelessly. Functional units may be implemented as hardware, software, or a combination of hardware and software.

Techniques associated with the characterization of rechargeable batteries are described in the following. The techniques described herein can be used together with the most varied types of batteries, for example with batteries based on lithium ions such as, for example, lithium nickel manganese cobalt oxide batteries or lithium manganese oxide batteries.

The batteries described herein can be used in different application areas, for example for batteries used in devices such as motor vehicles or drones or portable electronic devices such as, for example, mobile devices. It would also be conceivable to use the batteries described herein in the form of stationary energy storage devices.

The techniques described herein make it possible to characterize the battery on the basis of state monitoring. State monitoring can comprise ongoing monitoring of the load of the battery and/or a state prediction of the battery. This means that the state of the battery can be tracked by monitoring the load and/or can be predicted for a particular prediction interval in the future. In particular, an aging estimate of the state of health (SOH) of the battery can be carried out.

As a general rule, the SOH decreases as the aging of the battery increases. Increasing aging can occur if the capacity of the battery decreases and/or if the impedance of the battery increases. Various examples from those described herein can be at least partially implemented using a server. This means that at least a part of the logic associated with the state monitoring can be implemented on a central server, separate from the battery or the battery-operated device. To this end, particularly a communication connection can be established between the server and one or more management systems of the battery. By implementing at least, a part of the logic on the server, especially precise and computationally intensive models and/or simulations associated with state monitoring can be used. This makes it possible to implement state monitoring especially precisely. In addition, it may be possible to collect and use data for a collection of batteries, for example, in association with models based on machine learning.

In the various examples described herein, the state monitoring can be implemented, while the use of the battery is based on measured data from the battery. This means that the state monitoring is implemented particularly at a certain point in time during the life of the battery—with reduced SOH. The battery can then be in field operation. In this manner, it may particularly be possible to also consider the prior aging behavior of the battery. This also makes it possible to implement state monitoring especially precisely.

The state monitoring may particularly comprise a simulation of the state of the battery. The simulation of the state of the battery can be implemented on the basis of the measured data. This means that even parameters of the state of the battery not directly monitored can be determined in association with the simulation. Examples of some parameters which cannot be monitored directly would be an internal temperature or temperature distribution, current or voltage values, etc. Based on such information, especially precise state monitoring can be implemented.

An aging model can also be used in association with the simulation of the state of the battery. The aging model can describe the aging of the battery and particularly of the internal state of the batteries as a function of the load. Because the simulation is implemented together with the aging model, the future development of parameters of the state of the battery can be predicted for the prediction interval.

From this, it is clear that the state monitoring can be helpful both for the ACTUAL state as well as for a predicted state.

The techniques described herein enable parameterization of simulation parameters of the simulation. In particular, it may be possible, by means of the techniques described herein, to determine the values for the parameters of the simulation especially precisely so that the state monitoring of the battery can be carried out especially precisely.

Various examples relate, in particular, to the modeling of the thermal behavior. This relates, for example, to a thermal cell model. Details regarding the thermal cell model will be described next. The temporal temperature profile of a battery cell, e.g., of a lithium-ion cell or a different rechargeable cell, is determined, on the one hand, by the heat generated within the cell and, on the other hand, by the heat flows in the cell and between the cell and the environment. Accordingly, during modeling of the thermal behavior, there is a differentiation between heat generation and heat dissipation models.

In contrast to electrochemical energy, heat is a form of energy not bound to a substance and thus is not a state variable but rather a process variable. The effects of heat generation in battery cells occur in electrochemically active materials as well as all current-conducting materials. In principle, it is possible to differentiate between the following mechanisms of heat generation:

The irreversible generation of heat [symbol] ᵢᵣᵣ, or also Joule heat, results from the transport of lithium ions through the electrolytes and the intercalation electrodes (including the charge transfer at phase boundaries and the diffusion resistance of passivation layers) as well as through the flow of electrons through the active materials and arrester. These effects respectively lead to overvoltages, which is why the irreversible heat generation [symbol] ᵢᵣᵣ can be described with

\dot{Q}ᵢᵣᵣ=I(t)(U(t)−U_{ocv}(t)) (1)

in electronic-thermal cell models. This relationship only represents a worst-case estimate because it is assumed that all processes contributing to the voltage excess U(t)−U_{ocv}(t) are implemented with the same current strength I(t). The heat resulting in this case is always exothermic. If an equivalent circuit model is used for the electronic modeling, the irreversible power loss from Eq. (1) can also be calculated via the total of the power losses of all the resistive elements:

$${\dot{Q}}_{irr} = {\sum }_{i} {U}_{i} {I}_{i} \qquad ( 2 )$$

The reversible heat generation [symbol] ᵣₑᵥ is caused by the intercalation or the deintercalation of lithium ions into the host lattice by the anode and cathode and the chemical reactions associated therewith and may be endothermic or exothermic depending on the current direction and the coefficient of entropy. Using the Gibbs equation, the reversible power loss can be derived according to Eq. (2.3), where

$$\frac{{dU}_{eq}}{dT}$$

corresponds to the so-called coefficient of entropy.

$${\dot{Q}}_{rev} = - T \frac{{dU}_{eq}}{dT} I$$

The coefficient of entropy

$$\frac{{dU}_{eq}}{dT}$$

can be determined experimentally by means of calorimetry or via potentiometric measurements. An analytical calculation is only possible with precise knowledge of the cell structure and all sub-reactions.

Thus, techniques are described in the following by means of which it is possible to use the thermal simulation model with a cell model, which considers the generation and dissipation of heat. Techniques for parameterization are described.

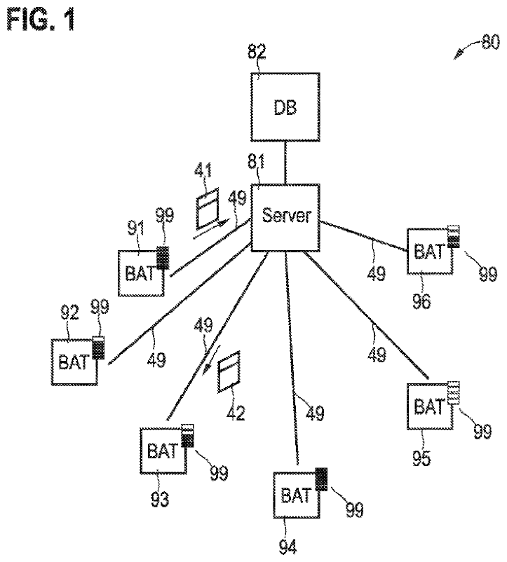

FIG. 1 illustrates aspects associated with a system 80. The system 80 comprises a server 81, which is connected to a database 82. In addition, the system 80 comprises communication connections 49 between the server 81 and each of several batteries 91-96. The communication connections 49 could be implemented, for example, via a cellular network.

In general, different battery types can be used in the various examples described herein. This means that the batteries 91-96 may comprise several types. Different types of batteries can be differentiated, for example, as relates to one or more of the following properties: shape of the cell (i.e., round cell, prismatic cell, etc.), cooling system (air cooling with active or passive design, coolant in coolant hose, passive cooling elements, etc.), the cell chemistry (e.g., electrode materials used, electrolytes, etc.), etc. There may also be a certain amount of variance between batteries 91-96 of the same type associated with such properties. For example, it is possible for batteries 91-96 of one and the same type to be mounted differently and thus different cooling systems are used. In addition, the same battery cells may sometimes be arranged differently such that there is variance in an electrical and thermal system analysis of the collection of cells.

As a general rule, such battery-specific and/or type-specific effects can be considered in association with the simulation in the various examples described herein. In particular, it may be possible to parameterize models of the simulation specific to type and/or specific to battery. FIG. 1 illustrates by way of example that the batteries 91-96 can transmit state data 41 to the server 81 via the communication connections 49. For example, it would be possible for the state data 41 to be indicative of one or more operating values of the respective battery 91-96, i.e., it is possible to index measured data. The state data 41 can be transmitted in an event-driven manner or according to a predefined timetable.

These state data 41 can be used, for example, in association with a thermal simulation and/or an electrical simulation of the respective battery 91-96. To this end, a simulation model can be stored on the server 81 for each of the batteries 91-96. It is possible in this case to use different simulation models for different batteries 91-96. In addition, it would also be possible to use different forms of parameterization for the respective simulation model for different batteries 91-96. This enables the formation of a “digital twin” for each of the batteries 91-96. Techniques are described in the following which enable the configuration and parameterization of the simulation models for the different batteries 91-96 precisely and quickly. In this manner, a well-suited simulation model or a well-suited parameterization can be used on a large number of batteries 91-96, respectively. FIG. 1 also illustrates by way of example that the server 81 can transmit the control data 42 to the batteries 91-96 via the communication connections 49. For example, it would be possible for the control data 42 to index one or more operating limits for the future operation of the respective battery 91-96. For example, the control data could index one or more control parameters for thermal management of the respective battery 91-96 and/or charge management of the respective battery 91-96. The server 81 can thus influence or control the operation of the batteries 91-96 through the use of the control data 42.

FIG. 1 additionally illustrates schematically the respective SOH 99 for each of the batteries 91-96. As a general rule, the SOH 99 of a battery 91-96 may comprise one or more different variables depending on implementation. Typical variables of the SOH 99 may be, for example: electrical capacity, i.e., the maximum possible stored charge; and/or electrical impedance, i.e., the frequency response of the resistance or alternating current resistance as a ratio between the electrical voltage and electrical current strength.

Techniques for state monitoring are described in the following, which make it possible to determine the SOH 99 and/or other characteristic variables for the state of the batteries 91-96 for each of the batteries 91-96 during use of the batteries 91-96. This means that, for example, the electrical impedance and/or the electrical capacity can be determined. This can take place on the server by means of the simulation model. The server 81 could then provide corresponding information regarding the SOH 99 to the batteries 91-96, for example via the control data 42. A management system of the batteries 91-96 could then adapt an operating profile for the batteries in order to prevent, for example, further degradation of the SOH 99.

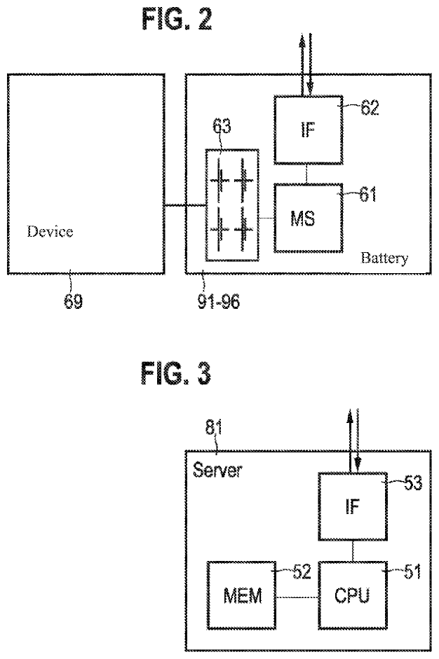

FIG. 2 illustrates aspects associated with the batteries 91-96. The batteries 91-96 are coupled to a respective device 69. This device is driven by electrical energy from the respective battery 91-96. The batteries 91-96 comprise or are associated with one or more management systems 61, e.g., a BMS or a different control logic such as an on-board unit in the case of a vehicle. The management system 61 can be implemented, for example, by software on a CPU. Alternatively, or additionally, an application-specific integrated circuit (ASIC) or a field-programmable gate array (FPGA) can be used, for example. The batteries 91-96 can communicate with the management system 61 via a bus system, for example. The batteries 91-96 also comprise a communication interface 62. The management system 61 can establish a communication connection 49 with the server 81 via the communication interface 62.

While the management system 61 is designated separately from the batteries 91-96 in FIG. 2, it is also possible in other examples for the management system 61 to be part of the batteries 91-96. In addition, the batteries 91-96 comprise one or more battery blocks 63. Each battery block 63 typically comprises a number of battery cells connected in parallel and/or in series. Electrical energy can be stored there.

Typically, the management system 61 can rely on one or more sensors in the one or more battery blocks 63. The sensors can measure, for example, the current flow and/or the voltage in at least some of the battery cells. Alternatively, or additionally, the sensors can also measure other variables in association with at least some of the battery cells to determine, for example, temperature, volume, pressure, etc. of the battery and to transmit this information to the server 81 in the form of state data 41. The management system 61 can also be configured to implement thermal management and/or charge management of the respective battery 91-96. In association with the thermal management, the management system 61 can control, for example, cooling and/or heating. In association with the charge management, the management system 61 can control, for example, a rate of charge or a depth of discharges. Thus, the management system 61 can set one or more boundary operating conditions for operation of the respective battery 91-96, for example, based on the control data 42.

FIG. 3 illustrates aspects associated with the server 81. The server 81 comprises a processor 51 and a memory 52. The memory 52 may comprise a volatile memory element and/or a nonvolatile memory element. In addition, the server 81 also comprises a communication interface 53. The processor 51 can establish a communication connection 49 with each of the batteries 91-96 and the database 82 via the communication interface 53.

For example, program code may be stored in the memory 52 and loaded by the processor 51. The processor 51 can then execute the program code. The execution of the program code causes the processor 51 to execute one or more of the following processes, as they are described in detail herein in association with the various examples: characterizing batteries 91-96; carrying out one or more state predictions for one or more of the batteries 91-96, for example based on operating values which are received from the corresponding batteries 91-96 as state data 40 via the communication connection; implementing an electrical simulation of batteries 91-96; implementing a thermal simulation of batteries 91-96; implementing state monitoring of the batteries 91-96; implementing an aging estimate of batteries based on one or more operating profiles; transmitting control data 42 to batteries 91-96, for example, in order to set boundary operating conditions; storing an event of state monitoring of a corresponding battery 91-96 in a database 82; etc.

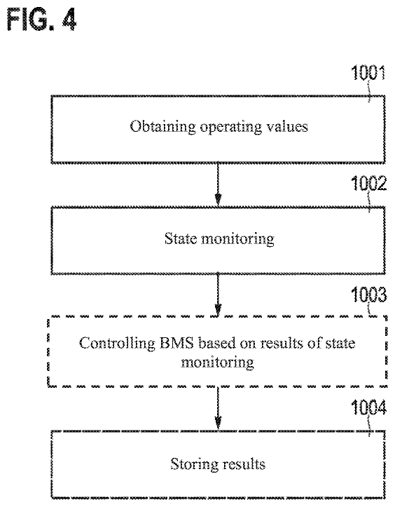

FIG. 4 is a flowchart of an exemplary method. The method is executed by a server. The method is used to characterize a battery on the server side.

This means that the method from FIG. 4 is used for state monitoring of the battery. For example, it would be possible for the method according to FIG. 4 to be executed by the processor 51 of the server 81 based on program code from the memory 52 (cf. FIG. 3). Optional blocks are shown with dashed lines in FIG. 4.

First, in block 1001, one or more operating values are obtained from the battery to be characterized. To this end, state data, for example, can be received via a communication connection between the battery and the server in block 1001. This means that measured data from the batteries to be characterized can be received.

The one or more operating values can relate, for example, to an SOH of the battery. The one or more operating values can relate, for example, to a capacity of the battery and/or an impedance of the battery. In general, it would also be possible for one or more additional or different characteristic variables of battery operation to be indexed by the one or more operating values. For example, in some examples, it would be possible for current data (for example a time series) and/or voltage data (for example a time series) to be indexed by the operating values. This means that the operating values could describe, for example, a time progression of the current in one or more cells of a battery block of the battery or they could describe a time progression of the electrical voltages in one or more cells of a battery block of the battery. The operating values could also describe, for example, a temperature in one or more regions of a battery. The operating values could describe, for example, a corresponding time series of temperature data. The operating values could also comprise an operating profile, i.e., a load characterization, for example a depth of discharge (DOD), rate of discharge, rate of charge, SOC cycles, etc.

Subsequently, state monitoring is implemented for the battery in block 1002 in order to characterize it. State monitoring can comprise the determination of the actual state of the battery as well as a state prediction using an aging model.

In this case, several state predictions can be carried out in block 1002. If several state predictions are carried out in block 1002, they can be associated with different boundary conditions of the battery operation. For example, the boundary operating conditions which are considered in block 1002 could relate to one or more of the following elements: a control parameter of thermal management of the battery and/or a control parameter of charge management of the battery. In general, the boundary operating conditions can determine certain conditions for operation of the battery which are triggered by the specific operating profile, which is determined, for example, by use of the respective device 69, which is associated with the corresponding battery (i.e., the load, charge drawn off, rate of discharge, rate of charge, depth of charge, etc.).

The one or more state predictions in block 1002 can be based on an operating profile which is derived from an operating profile which is indexed, for example, for the respective battery in a monitoring interval by means of the operating values from block 1001. For example, it would be possible for the operating profile used for the one or more state predictions in block 1002 to be determined based on measurements taken at the battery in the monitoring interval. This means that, for example, the measured DOD and/or measured SOC cycles and/or measured rates of charge, etc. can be used in association with the one or the several state predictions in block 1002. An especially reliable or precise state prediction can be enabled by the use of an operating profile for the one or more state predictions in block 1002, which is based on the specific operation of the corresponding battery in the monitoring interval.

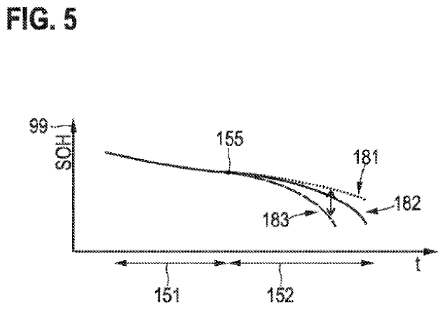

The state prediction can generate a time progression of aging for a prediction interval as a result. This is shown in FIG. 5.

FIG. 5 illustrates aspects in association with the aging of a battery, for example one of the batteries 91-96 from FIG. 1. FIG. 5 shows the SOH 99 as a function of time. The SOH 99 decreases as a function of time. This reduction in the SOH 99 can be determined by the state monitoring according to FIG. 4, block 1002.

Specifically, the SOH 99 decreases during a monitoring interval 151. The SOH 99 can be determined especially precisely by means of a simulation—which comprises, for example, a thermal model and/or an electrical model; to this end, one or more parameters of the battery can be precisely determined which otherwise could not be measured or only imprecisely. This can take place based on the operating values from FIG. 4, block 1001.

Then, at point in time 155 (ACTUAL point in time), a characterization of the battery takes place by means of implementation of several state predictions 181-183 for the battery. The state predictions 181-183 provide a prediction for the aging of the battery as a result, i.e., the SOH 99 during a prediction interval 152. FIG. 5 shows that the SOH 99 varies between the different state predictions 181-183, which is due to the different operating profiles upon which the simulation is based. The operating profiles can differ with respect to temperature, standby state of charge, rates of charge and discharge, end points of charge and discharge, cycle depth, and/or the average state of charge during charging and discharging, as well as combinations thereof. For example, it would be possible for state prediction 181—which results in a comparatively low reduction in the SOH 99 as a function of time during the prediction interval 152—to assume a different configuration of thermal management and a lower DOD as compared to state prediction 183—which results in a comparatively strong reduction in the SOH 99 as a function of time during the prediction interval 152. For example, the thermal management of the battery could enable lower operating temperatures due to active cooling as a boundary operating condition for state prediction 181. Now with reference again to FIG. 4: As a general rule, the state monitoring results from block 1002 can be used in various ways.

In one example, it would be possible to control a management system, which is associated with the respective battery, based on the results of state monitoring from block 1002; see block 1003. For example, it would be possible to determine control data (cf. FIG. 1, control data 42) based on the comparison of the results and to transmit this control data to the management system. As a general rule, one or more different parameters can be set for operation of the respective battery. For example, it would be possible for the control data to specify one or more operating limits for the future operation of the respective battery. Alternatively, or additionally, it would also be possible for the control data to specify one or more control parameters for thermal management and/or charge management of the battery. Such feedback of the results of one or more state predictions or generally the characterization of the battery makes it possible to enable an especially long-term operation of the respective battery.

However, it is not necessary in all examples for a feedback of the results of the one or more state predictions to occur in the operation of the battery. In this respect, block 1003 is an optional block.

In some examples, it would be possible, alternatively or additionally, to store the results of the state predictions in a database (cf. FIG. 1, database 82); see block 1004.

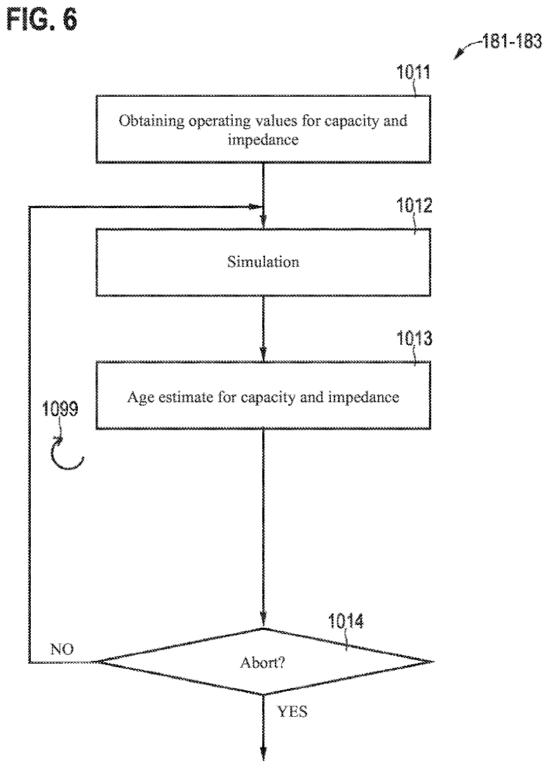

An exemplary implementation of the (optional) one or more state predictions in block 1002 will be described next in association with the flowchart from FIG. 6.

FIG. 6 is a flowchart of an exemplary method. The method according to FIG. 6 can be executed by a server. For example, it would be possible for the method according to FIG. 6 to be executed by the processor 51 of the server 81 based on program code from the memory 52 (cf. FIG. 3).

The method according to FIG. 6 is used as a state prediction for a battery. If several state predictions are to be implemented, the method according to FIG. 6 is carried out multiple times.

Initially, the operating values for the capacity and the impedance of the respective battery are obtained in block 1011. Thus, block 1011 corresponds to block 1001. This means that a current value is obtained for the SOH 99 of the battery. This typically occurs based on state data which are received by the respective management system, which is associated with the corresponding battery. This could also comprise the use of a simulation—e.g., with an electrical and/or a thermal model—in order to determine, for example, certain concealed state parameters of the battery which cannot be measured directly. These operating values are used to initialize the state prediction. Several iterations 1099 of the blocks 1012-1014 are then implemented. The various iterations 1099 correspond here to time-steps for the state prediction, i.e., the passage of time during the prediction interval 152.

First, the simulation of an electrical state of the battery and of a thermal state of the battery takes place in block 1012 by means of corresponding simulation modules for the respective time-step of the corresponding iteration 1099.

The simulation in block 1012 takes place with the inclusion of a corresponding boundary operating condition of the battery. This depends on the respective state prediction 181-183. In addition, a corresponding operating profile can be assumed for the operation of the battery.

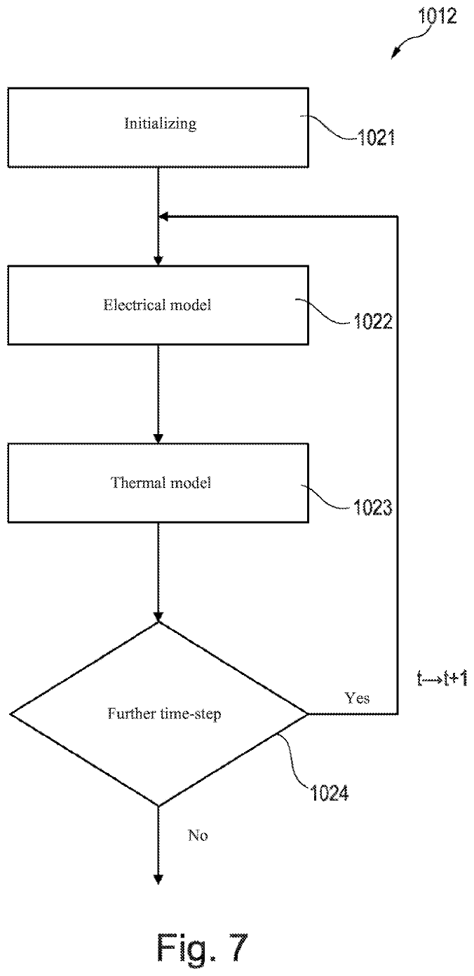

An electrical simulation model can be coupled to a thermal simulation model in order to simulate the electrical and thermal state. This is illustrated in FIG. 7.

FIG. 7 is a flowchart of an exemplary method. FIG. 7 illustrates aspects associated with the simulation of a battery, e.g., within the context of state monitoring.

The first thing that occurs in block 1021 is the initialization. For example, ACTUAL measured operating values can be obtained from the battery within scope of initialization.

A simulation of electrical variables of the cells is then implemented with the electrical model in block 1022. This can be based on the ACTUAL measured operating values of the battery. The electrical simulation module may use an equivalent circuit model (ECM) for the battery. The ECM may comprise electrical components (resistance, inductance, capacitance). The parameters of the ECM components can be determined, for example, by means of a Nyquist plot having the characteristic frequency domains of the transmission behavior of the cell block of the battery. An especially high number of RC circuits can be selected, e.g., greater than three or four, due to the implementation on the server 81. An especially high level of accuracy can thereby be achieved in the electrical simulation. In this case, one ECM can be used for each cell of a cell block.

The simulation of thermal variables of the cells is then implemented with the thermal model in block 1023.

The thermal simulation model makes it possible to determine the temperature curve over time and optionally the local temperature. In this case, heat sources (heat generation) and heat sinks (heat dissipation) can be considered. The discharge of heat to the environment can also be considered. Details regarding the heat generation model are described, for example, in: D. Bernandi, E. Pawlikowski, and J. Newman, “A General Energy Balance for Battery Systems,” Journal of the Electrochemical Society, 1985. Analytical or numerical models can be used for the local temperature distribution. The influence of thermal management can be considered. For example, refer to M.-S. Wu, K. H. Liu, Y.-Y. Wang, and C.-C. Wan, “Heat dissipation design for lithium-ion batteries,” Journal of Power Sources, Vol. 109, margin No. 1, pg. 160-166, 2002.

If a further prediction is intended, a new time-step can subsequently be initialized, in block 1024, and the electrical and thermal models can be reused. Otherwise, the simulation is completed. With reference again to FIG. 6, an aging estimate is implemented in block 1013 based on such electrical-thermal modeling, i.e., the capacity and the impedance of the battery are determined for the respective time-step based on a result of the simulation of the electrical state and of the thermal state of the battery.

Different techniques can be used together with the aging estimate. The aging estimate may comprise, for example, an empirical aging model and/or an aging model based on machine learning. For example, an empirical aging model and an aging model based on machine learning could be used in parallel and the results of these two aging models could then be combined through averaging, for example weighted averaging.

As a general rule, the empirical aging model could comprise one or more empirically determined parameters, which link an operating profile of the battery, which is obtained from the simulation in block 1012, to a worsening of the SOH 99, for example a reduction in the capacity and/or an increase in impedance. The parameters can be determined, for example, in laboratory measurements. An exemplary empirical aging model is described in: J. Schmalstieg, S. Kabitz, M. Ecker, and D. U. Sauer, “A holistic aging model for Li (NiMnCo)O2 based 18650 lithium-ion batteries,” Journal of Power Sources, Vol. 257, pg. 325-334, 2014.

In contrast thereto, an aging model based on machine learning may be continually adapted through machine learning based on state data which are obtained from different batteries of the same type. For example, artificial neural networks could be used, for example a convolutional neural network. Another technique comprises the so-called support vector method (support vector machine). For example, data from a collection of batteries (cf. FIG. 1, batteries 91-96) can be used in order to train a corresponding algorithm using machine learning.

Subsequently, there is a check to determine whether an abort criterion is fulfilled in block 1014. If this is not the case, block 1012 is repeated for a next time-step in the prediction interval 152, i.e., for the next iteration 1099. In this case, the particular capacities and impedances determined in the previous iteration 1099 are used, i.e., the simulations in block 1012 build upon each other. The iterative adaptation of capacity and impedance enables an especially precise state prediction.

When the abort criterion in block 1014 is fulfilled, the state prediction is completed. Examples of abort criteria comprise the following: number of iterations 1099; end of the prediction interval 152 reached; exceeding or undershooting threshold values for the capacity and/or the impedance; etc. Next, details regarding the thermal model (cf. FIG. 7, block 1023) and regarding the electrical model (cf. FIG. 7, block 1022) are described.

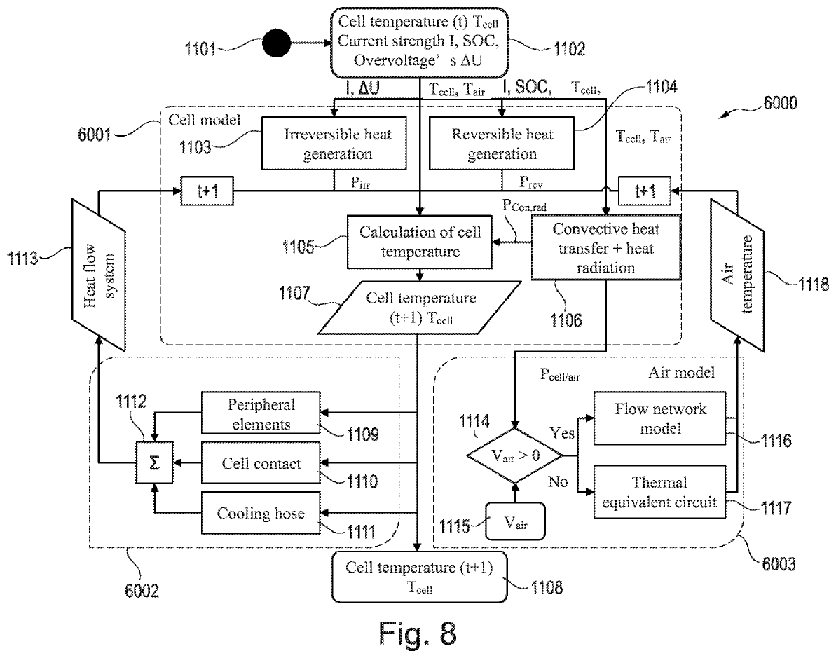

FIG. 8 illustrates aspects associated with the thermal model.

FIG. 8 shows that the thermal model comprises several sub-models 6001-6003. In particular, the thermal model 6000 comprises a cell model 6001, i.e., a thermal model for the individual cells of the battery. The thermal model 6000 also comprises an air model 6003. The air model 6003 describes an exchange of heat between the cells of the battery and the ambient air. The thermal model 6000 also comprises a thermal system model 6002. This model describes the exchange of heat between the cells of the battery and a respective environment.

Subsequently, the functionality of the thermal model 6000 will be explained. The model is initialized at 1101. A series of parameters 1102 are transmitted during the initialization 1101. Exemplary parameters 1102 particularly comprise the temperature of the various cells. This temperature can be measured and obtained in the form of state data 41 as operating values. In addition, the current strength I in the various cells is obtained as well as a state of charge SOC. The various overvoltages can also be obtained. These values can then be measured or obtained, for example, from the electrical simulation model.

These parameters are then supplied for the calculation of the irreversible heat generation at 1103 and supplied for the calculation of the reversible heat generation at 1104.

The irreversible portion of the heat generation in block 1103 is dependent on the electrical cell voltage and the current flow in the cells. The reversible portion of the heat generation model in block 1104 is dependent on a coefficient of entropy, the temperature, and the cell current.

The heat generation models represent the interface between the electrical state or the output of the electrical model and the thermal model. In addition to the irreversible generation of Joule heat (block 1103) Qᵢᵣᵣ, which results directly from the electrical model by means of the total of the overvoltage's Uₒᵥ multiplied by the current I, the reversible heat Qᵣₑᵥ (block 1104) is also considered by means of the coefficient of entropy

$$\frac{{dU}_{eq}}{dT}$$

and the temperature T in the heat generation model:

$$\dot{Q} = {\dot{Q}}_{irr} + {\dot{Q}}_{rev} = I ( \sum {U}_{ov} - T \frac{{dU}_{eq}}{dT} ) \qquad ( 4 )$$

The coefficient of entropy can typically be assumed as a constant over temperature.

The coefficient of entropy is determined, for example, by means of potentiometric measurements. Other examples comprise the recording of an open-circuit voltage curve at several temperatures or a calorimetric measurement.

A reference implementation for potentiometric measurements is described, for example, in: A. Eddahech, O. Briat, and J.-M. Vinassa, “Thermal characterization of a high-power lithium-ion battery: Potentiometric and calorimetric measurement of entropy changes,” Energy, Vol. 61, pg. 432-439, 2013.

In the potentiometric measurement, a temperature jump can be applied at several temperatures respectively and the change in the open-circuit voltage can be measured.

In a specific example, the potentiometric measurements involve the cells being respectively discharged, starting from the completely charged state, in 10% SOC intervals of 1C at 25° C. and subsequently relaxed for a time (min. 5 h up to 48 h depending on the cell) until the open-circuit voltage is set in gradients of

$$\frac{{dU}_{OCV}}{dt} < 2 \frac{m V}{h} .$$

Following this, respectively defined rapid temperature changes are carried out at 5, 25, and 45° C. with 5 h wait time each for acclimatization. The open-circuit voltage values at the end of the acclimatization phases are stored and used to form the linear coefficient of entropy

$$\frac{{dU}_{eq}}{dT}$$

for the respective SOC interval.

It is then possible to carry out the potentiometric measurement at several states of charge of the cells, i.e., with several SOC values. In this manner, the coefficient of entropy can be determined for the several states of charge. In particular, the coefficient of entropy may have a dependency on the state of charge. For example, it has been observed that a significant deviation in the coefficient of entropy occurs for states of charge less than 20%. Alternatively, or additionally, it would also be possible for the coefficient of entropy to be determined separately for the charging and discharging of the battery. This means that the several states of charge can be determined as a function of a charge direction or a discharge direction.

It is then possible to use different values for the coefficient of entropy, each as a function of the SOC and/or the charge or discharge direction, in association with the reversible heat generation in block 1104.

The cell temperature can be determined in block 1105 as a function of the heat generation from blocks 1103-1104. Block 1105 implements a heat dissipation model. As a general rule, different types of heat dissipation models are conceivable. In particular, heat dissipation models of various complexity can be used depending on the cell types or required accuracy.

When choosing the heat dissipation model, a selection can be made from modeling approaches of differing complexity. Decisive in this case are the temperature differences and heat gradients which occur for a given battery system under anticipated load scenarios and which should be precisely modeled accordingly.

The cell format, cooling system, and battery pack design used have significant influence on this. The temperature development in the electrode coil is of particular interest for an aging prediction of lithium-ion cells. For example, a relationship has been determined between the volumetrically averaged coil temperature and the cell degradation of thermally homogeneous cells of the same temperature. On the other hand, it has been determined that the thermal non-homogeneity itself does not indicate any significant additional degradation. For a battery pack configuration with expected non-homogeneous cell coil temperature, the volumetric mean value must be calculable accordingly in order to enable valid state monitoring. Moreover, when there are large temperature differences within the cell, knowledge of the distribution thereof is necessary in order to detect any safety-critical hot spots. There are basically two options for determining the heat gradients and thus the necessary spatial domain dimensionality of the thermal model for a given battery system. Firstly: Experimental measurement: The temperature development due to load is measured directly by means of temperature sensors placed on and primarily in the cell. The incorporation of temperature sensors in the interior of the cell can represent significant preparation effort. The temperature distribution in the active material can only be estimated by sensors on the cell housing because this temperature distribution is influenced by the housing material (aluminum or steel) which has comparatively good conductive behavior.

Secondly: Simulative investigation: The temperature differences occurring during operation can be analyzed simulatively with the heat generation from, for example, an electrical model by means of a cell model, with three-dimensional resolution, that considers the connection of the cooling system via temperature or boundary heat flow conditions. This can be carried out with a finite element simulation for various cooling configurations.

An operating profile, which is obtained, for example, using the state data 41 for the specific battery within the context of field operation, can be based on both the experimental measurement as well as the stimulative investigation. Thus, this means that, for example, load, charge drawn off, rate of discharge, rate of charge, depth of charge, etc. can be considered as a function of the specific operation.

It is then possible to consider the result of such a simulative and/or experimental investigation of the spatial domain temperature gradients in the cells in order to determine the spatial domain dimensionality of the heat dissipation model. For example, if significant temperature gradients in the spatial domain are determined experimentally or by means of simulation, a heat dissipation model with greater dimensionality can then be used, which is defined, for example, in 2D or 1D. Otherwise, a 0D heat dissipation model could be used. As a general rule, 3D heat dissipation models would also be possible. For example, it has been determined that a 3D heat dissipation model may be especially helpful for cells which are not arranged in a Cartesian coordinate system but instead, for example, are offset with respect to one another.

It has been found that a determination can be made, oftentimes depending on the cell type and/or depending on the cooling system of the battery, without experimental or stimulative investigation, as to whether sufficient results can be achieved by means of a heat dissipation model of lower dimensionality in the spatial domain. For example, it has been determined that a 0D heat dissipation model may be sufficient for a round cell, regardless of the specific type of cooling (jacket cooling, arrester cooling, or no cooling). This is different for a prismatic cell. Typically, a 2D model may be necessary for the heat dissipation of these cells.

In this case, the cell model may be defined analytically for a spatial domain dimensionality of 0D and may be defined numerically with finite elements for a spatial domain dimensionality of 1D or 2D (wherein a mesh density for the simulation within the context of state monitoring may be significantly less than a mesh density for the calibration simulation in order to determine the required spatial domain dimensionality as described above). The same can be true for a 3D spatial domain dimensionality.

In order to validate the selection of the spatial domain dimensionality of the dissipation models, the stationary and non-stationary thermal conductivity can be assessed in a calorimeter measurement under defined power loss specifications. This will suppress any error propagation from the electrical model. The following are selected as load cycles, for example:
Constant power loss: several phases with alternating charge/discharge pulses (lasting 1 s) in respectively varying charge rates (C-rate); pauses respectively defined between the various C-rates; duration of loads and pauses are selected such that a stationary temperature level is respectively achieved.
Sinusoidal profile: constant power profile modeled with a sinusoidal signal, from which a sinusoidal power loss profile of 0 to Pₘₐₓ results; amplitude and frequency are selected such that a sinusoidal temperature response results with constant amplitude and frequency.

Both load cycles are SOC-neutral (apart from the 1 s pulses), whereby there is no resulting non-directly measurable reversible heat generation. The irreversible heat generation P_{V,r} is calculated using terminal voltage U_{Terminal} and current I_{Terminal} and specified according to the dissipation model:

P_{V,irr}=(U_{Terminal}−U_{OCV})I_{Terminal}

In order to analyze the temperature distribution of the cells, they can each be provided with several temperature sensors on the cell housing.

Measurements can be carried out in a thermally controlled cabinet at constant temperature. The ambient temperature is measured. Initially only free convection and radiation are assumed as the types of heat transport. The cells are placed upright, for example, on a rubber mat.

The temperature distribution of the cells can then be observed for both validation cycles, for example, with a maximum constant power loss of about 0.3 W. There can then be a check to determine whether, for example, the selection of a heat dissipation model with 0D spatial domain dimensionality is justified as a function of the size of the temperature distribution.

The heat dissipation model can thus be configured as previously mentioned and it obtains the heat generation from blocks 1103 and 1104 as an input. FIG. 7 clearly shows that the cell temperature is determined with the heat dissipation model in block 1105 both as a function of a heat flow from the system (block 1113) and as a function of the air temperature (block 1118). To this end, the system model 6002 and the air model 6003 are used.

The cell model calculates the cell temperatures for each time-step (block 1107) based on the reversible and irreversible power loss P_{V} as well as the heat dissipation flows. The dissipation flows in this case are composed of a convective heat flow P_{Conv} and heat radiation P_{Rad} (from the air model, block 1106) as well as from the various heat flows of the system model P_{pack}. Consequently, the cell temperature is calculated as follows in the 0D heat dissipation model:

$${T}_{2} = {T}_{1} + {\int }_{{t}_{1}}^{{t}_{2}} \frac{{P}_{Conv} + {P}_{Rad} + {P}_{V} + {P}_{Pack}}{{mC}_{p}} dt \qquad ( 5 )$$

where m corresponds to the cell mass and cₚ corresponds to the heat capacity. In the 2D heat dissipation model, the power loss P_{V} is uniformly distributed onto the active material, and the temperature distribution within the cell is calculated with the finite element method using Fourier's differential equation. The dissipation flows through the air and system components are considered according to the defined side surfaces.

Details regarding the air model 6003 will be described next. With the air model 6003, there is a differentiation between free or forced convection (block 1114) depending on air speed (block 1115). With free convection, a thermal air mass of ambient air is initialized for each cell. This is then linked to the adjacent air masses or the environment (boundary temperature condition) via resistors (block 1117). Forced convection is depicted by means of a flow network model (block 1116). In the cell model, first the heat flows between the cells and the corresponding air control volumes are calculated by means of correlation relationships (block 1106). In the air model, the heat flows of fluidically parallel cells are then added to P_{Conv} and the temperature increase ΔT of the air mass flow

$$\frac{dm}{dt}$$

is determined according to Eq. (6) with reference to the defined flow direction.

$$Δ T = \frac{{P}_{Conv}}{{C}_{p} \frac{dm}{dt}} \qquad ( 6 )$$

Details regarding the system model 6002 will be described next. The system model 6002 bundles three general cell effects: heat exchange between the cells (block 1110), heat exchange between the cells and the peripheral elements (block 1109), and heat exchange between cells and a fluidic cooling element, e.g., a hose with coolant flowing through it (block 1111). These effects are added in block 1112.

The heat exchange between cells can be defined in 2D and parameterized with corresponding contact resistances. Conduction with peripheral elements, such as current conductors, heat-conducting sheet metal, or assembly elements, or other solid body cooling elements, can likewise be set specific to the cell. The peripheral elements are initially analytically parameterized, for example, and corrected experimentally as needed. In addition to the influence of the solid body, the peripheral model can likewise depict temperature control by means of coolant as long as it is present at a constant temperature in two phases. The depiction of a coolant flowing through the battery pack with changing temperature is implemented in block 1111 of the system model 6002. The sequence in which the coolant passes through the cells is set in 2D using a matrix.

There are various strategies here for implementing parameterization of the system model 6002, i.e., for obtaining the values for the various parameters such as, for example, contact resistances, thermal capacities, etc.

In one example, the parameterization of contact resistances and/or thermal capacities of the heat exchange between the cells of the battery, of the heat exchange of the cells with the solid body cooling element, and of the heat exchange of the cells with the fluidic cooling element is based on predefined reference values. These values can be obtained from the literature, for example, for the various materials. Material- and substance-specific characteristic values of the peripheral elements and cooling system can be found in the literature.

It would then be possible to subsequently adapt this parameterization in order to obtain greater accuracy. In particular, such validation can take place at the cell level or system level (i.e., with consideration of the system model 6002 and the air model 6003).

The thermal capacities of individual cells can be determined with a calorimeter. In this case, rapid temperature changes of ±1° C. are implemented with the cell inserted and the heat capacity P_{Z} required for this is recorded. The rapid changes can be repeated with an empty calorimeter (heat capacity PB). The heat capacity of the cell results according to Eq. (7) as:

Cₚ=∫₀^{t}^{₁}P_{Z}(t)dt−∫₀^{t}^{₁}P_{B}(t)dt−2P₀^{t}₁ (7)

Typical specific heat capacities are in a range of from 700 to 1000 J/(kg K).

A calorimetric measurement of heating can also be used to determine the coupling of several cells to each other and to the peripheral elements or air. Several cells can be placed into a reference matrix arrangement. This means that adjacent cells can be arranged spaced apart from one another. The forced convection can thereby be measured for a flow network model with correlation relationships. The reference matrix arrangement can be incorporated into a flow channel. The flow rate can be set by means of an axial flow fan. The temperature distribution can be measured with a temperature gauge distributed along the reference matrix arrangement. The parameterization of the contact resistances and/or the heat capacities can be adapted from this.

The anisotropic thermal conductivity values of the cells as well as the heat transfer coefficient thereof for certain reference configurations can be determined by means of thermal impedance spectroscopy (TIS). In this case, a sinusoidal power loss of varying frequency is superimposed on the cell and the temperature response is measured on the cell surface. Thus, characteristic thermal values can be determined via the transfer function of the thermal dissipation model and the calculated thermal impedance.

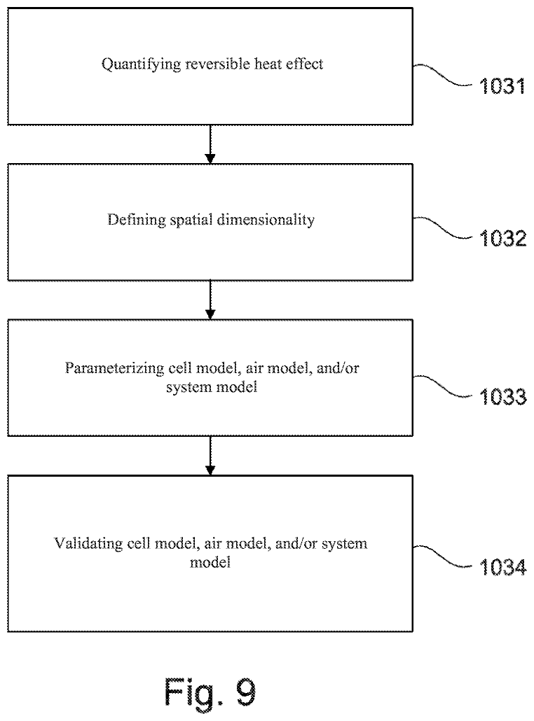

FIG. 9 is a flowchart of an exemplary method. The various techniques described previously for parameterization of the thermal model 6000 are compiled in FIG. 9. Parameterization of the thermal model 6000 (cf. FIG. 8) is possible by means of the technique from FIG. 9.

In this case, there may be various trigger criteria which trigger parameterization according to the method in FIG. 9. In one example, a type-specific parameterization could occur. This means that the server 81 can manage, for example, a catalog of different types of batteries 91-96 in the database 82 (cf. FIG. 1). Whenever a simulation is initialized (cf. FIG. 7, block 1021), the server 81 can access the database and read out the corresponding values of the parameters for the respectively current battery type. In other examples, it would also be possible for the parameterization to take place specific to the battery. In such a case, a catalog of different batteries 91-96 in the database 82 can be managed by the server 81. The server 81 could then identify the respectively current battery and load the corresponding operating parameter values. Finally, it would also be possible to adapt the parameterization, at least partially, for each simulation. A new parameterization could then be initiated during the execution of block 1021. An exemplary application scenario relates, for example, to the selection of the complexity of the simulation model. It can sometimes be sufficient to select a less complex simulation model, for example, based on the specific operating profile of a corresponding battery 91-96. One example relates, for example, to the spatial domain dimensionality of a heat dissipation model of the thermal simulation. When the operating profile indexes, for example, a low battery load (slow charging or discharging, etc.), the temperature gradients within the battery can then be low. A lower spatial domain dimensionality can then be used for the heat dissipation model.

The quantification of the model for heat generation initially takes place in block 1031. To this end, particularly a reversible portion can be parameterized. For example, a potentiometric measurement can be carried out for this, and a coefficient of entropy can be determined in this manner. Cf. Eq. 3.

Subsequently, the spatial domain dimensionality of the heat dissipation model is determined in block 1032. There are various options for this. For example, a finite element simulation of the cell geometry can be implemented, in which an especially high level of accuracy can be used in association with this simulation (narrow simulation mesh). In particular, a 3D simulation can be carried out. A temperature gradient can then be observed. If the temperature gradient for typical load parameters does not fall below a particular threshold value, a 0D model could then be used for the heat dissipation. Such a 0D model can particularly be determined analytically. Otherwise, a 1D or 2D model could be used. The size of the heat gradient often depends on the operating profile as well. Therefore, the operating profile can be considered in block 1032. For example, a current operating profile of the respective battery could be obtained by means of state data 41. With less loading of the battery, less heat may result and thus the heat gradient may also be smaller and thus a 0D or 1D model may be sufficient (instead of a 2D model).

Subsequently, the parameterization of the cell model, the air model, and/or the system model 6001-6003 takes place in block 1033. To this end, values from the literature can be used, for example, for the heat capacity and/or the thermal conductivity of certain contact resistances. It would also be possible to implement one or more calorimetric measurements, for example, in order to adapt values first initialized; see block 1034. A heat capacity of the cells can be determined by means of the calorimetric measurement. A TIS can also be implemented in block 1034, for example, in order to determine the anisotropic heat transfer coefficient of the thermal cell model 6001.

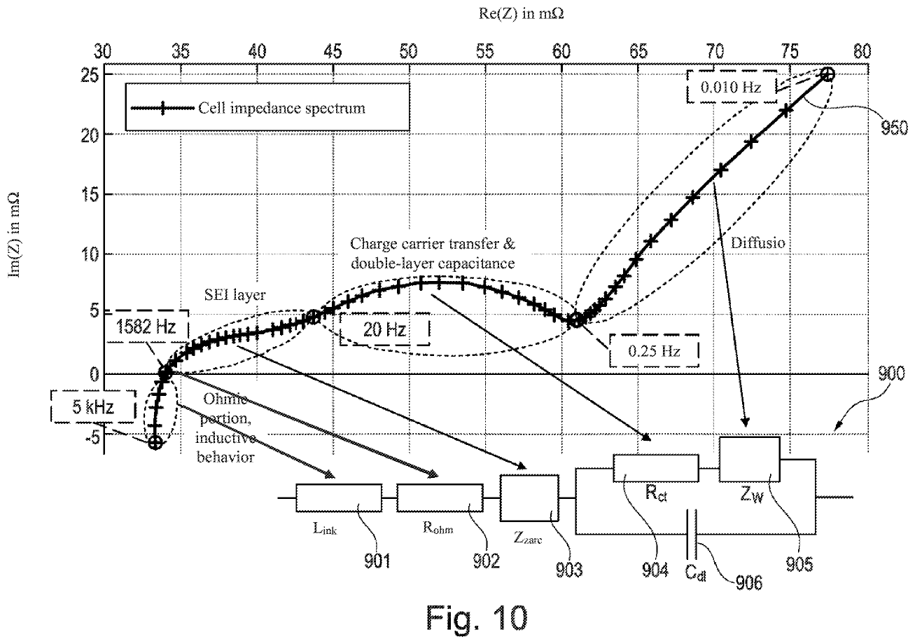

FIG. 10 illustrates aspects associated with the electrical model 900; see FIG. 7, block 1022. The electrical model 900 is based on an equivalent circuit diagram model. The electrical model can provide the cell current flow and the cell voltage. The variables can then be used as an input for the heat generation model (cf. FIG. 8, block 1102).

The underlying principle of equivalent circuit models (ECMs) is the depiction of electrochemical cell behavior with the aid of a connection of electrical components 901-906. Depending on the level of detail, individual effects of the cell components can be combined or considered separately. The general design of an ECM will be depicted in the following using the impedance spectrum of an exemplary cell (Panasonic NCR18650PF). FIG. 10 illustrates the impedance spectrum 950 of the cell in a Nyquist plot. The inductive behavior is shown in the negative region of the Nyquist plot at high frequencies, constrained by the arrester at the poles and the metallic housing itself. This is normally modeled by a constant inductance L 901 in series with the remainder of the ECM components 902-906.

The point of intersection between the impedance curve and the real part axis is typically in the range of about 1 kHz and corresponds to the purely ohmic internal resistance of the cell as a total of the limited conductivity of the current conductor, of the electrode material, of the electrolyte, and of the separator. For modeling purposes, a purely ohmic resistance Rₒₕₘ 902 can be used accordingly as a function of SOC, temperature, and state of aging.

After the zero crossing, there is a first circular arc, which reflects the polarization effects at the passivation layers of the anode (solid electrolyte interface, SEI) and the cathode (solid permeable interface, SPI). The effect of the SPI layer in this case is usually weaker than that of the SEI. The SEI layer growth is considered to be the primary aging mechanism for lithium-ion cells with a graphite anode, which is why this dynamic effect becomes stronger as the state of aging continues and oftentimes cannot be observed separately for new cells.

There is a second semicircular arc following this caused by the charge transfer reaction at the electrode/electrolyte boundary layers combined with the double-layer capacitance. In this case, the charging zone which results at the contact surfaces of the anode and cathode with the electrolyte is mentioned as the double layer capacitance C_{dl} (dl for double layer). The amount of charge stored therein depends on the electrode potential. Since the double-layer capacitance develops at the electrode/electrolyte boundary layers, it occurs at the anode and cathode in parallel with the charge transfer redox reaction. Due to the transition from ionic to electrical conduction, this transfer reaction causes a polarization overvoltage which is typically depicted by the charge transfer resistance R_{ct} (ct for charge transfer) for the ECM. Since the anode and cathode essentially have different parameters, two separate semicircular arcs can also occur in the impedance curve. By means of the individual circular arcs for the cell being examined, it can be concluded that either the charge transfer resistance of an electrode (for example the graphite anode) is comparatively small as relates to the other electrode or that both charge transfer reactions show a similar dynamic behavior. The double-layer capacitance C_{dl} and the charge transfer resistance R_{ct} essentially depend on the SOC, temperature, current rate, and state of aging.

With the semicircular arcs of the charge transfer/double-layer capacitance and SEI layer, it is apparent that they have a compressed form in the direction of the imaginary axis. This phenomenon occurs when the time constant of the electrochemical effect does not have a fixed value but instead a distribution about a mean value. The distribution results from the superposition of processes occurring in parallel (such as simultaneous charge carrier transfer at the anode and cathode) and from the spatial expansion of the electrode/electrolyte boundary layer in porous electrodes. However, since a regular RC circuit only depicts an ideal semicircle in the complex plane, so-called Zarc elements 903 are used to model compressed circular arcs.

In the low frequency range, the impedance spectrum finally ends at practically a 45° angle, which is due to the diffusion behavior as a result of ion concentration differences in the electrolyte and the electrodes. Precise modeling of the substance transmission phenomena from diffusion is difficult with R-L-C elements. A suitable approach for depicting the porous electrode structure would be so-called conductive elements (transmission lines). However, since they have a complex transfer function and a high number of required parameters, so-called Warburg elements are used in the literature. There are three different variants of these which differ in terms of the boundary condition at the end of the diffusion path.

The impedance curve of a lithium-ion cell can be depicted very well and thus the form of the individual electrochemical effects can be analyzed with a combination of the previously presented elements. However, with the transformation of the transmission behavior in the time domain, some elements of the frequency domain (constant phase, Zarc, and Warburg elements) are approximated due to a lacking Laplace transform. In addition to conductor networks, RC circuits connected in series represent the most common variant for the approximation. For Zarc elements 903, an uneven number of RC circuits (3, 5, etc.) is recommended to depict the compressed semicircular shape in the best way possible.

Basically, the number of RC circuits used for the approximation of the dynamic cell behavior over the frequency domain relevant for use always represents a compromise among accuracy, computing time, and parameterization complexity.

In addition to the dynamic cell behavior, the static behavior without load can also be modeled in an electrical ECM. The so-called open-circuit voltage (OCV) depends on the electrode materials used and the balancing thereof which can change with age. It is usually modeled by means of an SOC-dependent ideal voltage source. Furthermore, a temperature dependency as a result of changes in entropy can be considered which is typically less pronounced. With certain electrode materials, such as LFP cathodes, a significant hysteresis effect also occurs with respect to the previous current load.

In various examples, it would be possible to also consider a hysteresis associated with the modeling of the open-circuit voltage as an alternative or addition to an SOC-dependent ideal voltage source for modeling the open-circuit voltage. This can thus mean that the open-circuit voltage has a dependency on the direction of current flow. Corresponding transition coefficients can be considered in order to model the open-circuit voltage during a switch from one current direction to another current direction. These can model the transition from the characteristic curve of the open-circuit voltage which is associated with one current direction to the characteristic curve of the open-circuit voltage which is associated with the other current direction.

The previous section explained the modeling of lithium-ion batteries at the cell level. The step for electrical stimulation of a battery system—i.e., of the electrical system model—can occur at different levels of detail:

(i) Scaling of a cell system: In this simplest case, the entire battery pack is depicted by an individual cell model. The system voltage results as a product from the cell voltage and number of cells in series, and the system current is divided by the number of parallel cells and provided to the cell model. In this manner, the parameters of the cell model do not have to be adapted.

(ii) Modeling of a series connection, scaling of a cell parallel connection: In this case, each serial cell string is depicted by its own cell model. Parameter spreads and the resulting effects can thereby be depicted, such as SOC drifts and non-uniform aging behavior of the serial strings. Existing parallel connections in the battery system are simulated as in 1.).

(iii) Modeling of connection in series and in parallel: At this level of detail, each cell in the battery system is simulated by means of its own cell model. In addition to (ii), also the effects of the parallel connection can thus be depicted, such as different current loads and the resulting SOC window with parameter spreads.

The accuracy of electrical equivalent circuit models largely depends on the quality of the model parameters.

During parameterization of the dynamic equivalent circuit parameters, there can be a differentiation essentially between methods in the time and frequency domain. One method in the time domain is the dynamic stress test measurement (DST); refer to USABC Electric Vehicle Battery Test Procedures Manual, Rev. 2 (1996). A further method in the time domain is the evaluation of the voltage response of a cell to an applied current pulse (current pulse characterization measurement). A parameter set can be numerically determined (fitting), which depicts the measured voltage response with a maximum defined error, by means of the transfer function of the model and an error-minimizing optimization algorithm. The problem with this method is that while potentially mathematically reasonable values for simulating the voltage response can be found through local minimums in the optimization, these values do not have the intended electrochemical equivalence and thus inevitably lead to simulation errors with different load profiles. A further option for parameterization in the time domain is the calculation of direct-current resistances to applied constant current pulses according to defined time periods. The times should be defined such that the resistance values have an electrochemical significance (for example R_{DC,1s} for the charge carrier transfer resistance). With the electrochemical impedance spectroscopy (EIS) measurement in the frequency domain, the cell is exposed to a sinusoidal excitation signal (usually current, galvanostatic EIS) with constant frequency points in a defined frequency band, and amplitude and phase shifting of the system response (voltage in the galvanostatic EIS) are measured. The advantage here is the ability to separately observe dynamic effects with different time constants. The Nyquist diagram according to FIG. 10 shows a common representation of the impedance curve. Using the complex transfer function of the equivalent circuit, the dynamic model parameters can then be determined by means of the fitting method within the context of parameterization. Since the actual excitation signal with the EIS sinusoidal alternating current is about the zero position, an additional direct-current offset is typically applied for measuring a current rate dependency. However, this changes the state of charge, which is why a suitable compromise must be found between the DC offset and the duration of the EIS measurement. There are two different methods for parameterization of the ideal voltage source in the ECM in order to model the open-circuit voltage: With the measurement of relaxation current, the lithium-ion cell is discharged from a fully charged state or charged from a fully discharged state in increments to defined states of charge, and there is a wait for a defined time period without load, in which all the kinetic effects, such as overvoltages and concentration gradients, should be degraded. The wait time in this case is typically in a range of several hours, wherein the degradation of all overvoltages can last even several days depending on the SOC and cell temperature. The relaxed voltage values at the end of the wait time then provide a charge and discharge open-circuit voltage curve. If both curves are compared for a respectively equivalent SOC, a discrepancy in values is determined, which is characterized as the hysteresis effect. This dependency of the open-circuit voltage on the history depends on the cell chemistry, the SOC, and to a lesser extent the temperature. This is especially pronounced in electrode materials with two-phase transitions such as lithium iron phosphate. During the measurement of the constant current for parameterization of the ideal voltage source in the ECM, the lithium-ion cell is charged and discharged with low, constant current over the entire SOC range. Due to the low current rates (typically between C/50 and C/10), a quasi-stationary state with only low overvoltages can be assumed. By averaging the charge and discharge curves, they are eliminated, and a quasi-open-circuit voltage characteristic curve is obtained. The test time in this case is normally significantly shorter as compared to the relaxation measurement, and the number of measuring points is significantly higher due to the continual measurement. However, hysteresis effects cannot be quantified by this method. Moreover, constant current curves are frequently used in the literature for determining intercalation potentials of half or full cells by means of differential voltage analysis (DVA).

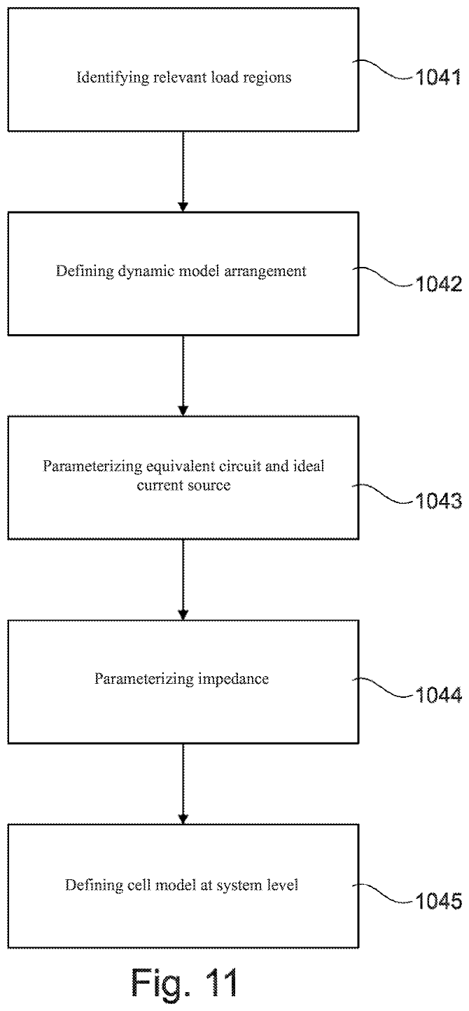

FIG. 11 is a flowchart of an exemplary method. The method according to FIG. 11 can be used to implement parameterization of the electrical model 900.

First, one or more relevant load regions can be identified in the frequency domain in block 1041. The load regions correspond to those regions which are represented in the load profile of the battery—i.e., which have significant amplitude. To this end, the operating profile of the battery can be considered—for example by indexing the state data 41.

Such techniques are based on the following knowledge: In order to depict as precisely as possible, the current and voltage behavior and thus the heat generation and aging factors for a specific application, the respective electrical load and environment profile should be considered during model definition. For application with vehicle batteries in the vehicle development process, this profile can be derived either from relevant driving cycles in conjunction with a longitudinal dynamic simulation or from measurements on a real vehicle. On the one hand, the operating ranges of current, temperature, and SOC of the battery pack and thus the necessary ranges of model parameterization are determined from this by means of amplitude analysis.

On the other hand, the dynamics of system excitation in the frequency spectra can be quantified and thus the relevant frequency domains can be determined with respect to the electrical model by means of the discrete Fourier transform of the current signal. For a typical measurement on a passenger car, these results, for example, in a relevant range of up to about 1 Hz. This can depend on the driving style of the driver. Using this information and the dynamic transmission behavior of the lithium-ion cells of the battery pack from the EIS, the relevant electrochemical processes for modeling and thus the system order of the dynamic electrical model can be determined in the next step.

This means that the dynamic model order is defined subsequently in block 1042. Electrochemical impedance spectroscopy is especially well-suited for identifying the impedance effects relevant for an application and its specific time constants due to the sequential measurement of various frequency domains. In order to define the dynamic model order, the respective cells are thus measured in the operating ranges of temperature and SOC identified in block 1041, each with a hybrid EIS in the frequency domain of 5 kHz to 10 MHz the number of interpolation nodes in this case represents a compromise between resolution and measurement time.

With the aid of the impedance curves obtained, the electrochemical effects that are relevant and to be depicted in the electrical model are identified by means of their time constants, e.g., the inductive portions of the impedance or the impedance sections with a negative imaginary part. In order to evaluate the modeling quality of the impedance behavior and to parameterize various ECMs (i.e., in order to determine, e.g., the number of RC circuits), a parameter fitting can be used for EIS measurements, based on the method of least squares:

$$S = {{\sum }^{N}}_{n = 1} {{w}_{1} [ {Z}_{Re}^{exp} - {Z}_{Re}^{calc} ( ω , P ) ]}^{2} + {{w}_{i} [ {Z}_{Im}^{exp} - {Z}_{Im}^{calc} ( ω , P ) ]}^{2} \qquad ( 8 )$$

In the cost function S, Z_{Re}^{exp} and Z_{Im}^{exp} or Z_{Re}^{calc} (ω, P) and Z_{Im}^{calc} (ω, P) each represent real and imaginary parts of measurement and model fit with the parameter vector P. Frequency-dependent weighting factors can be added via wᵢ. Z_{Re}^{calc} (ω, P) and Z_{Im}^{calc} (ω, P) result from the transfer function of the selected ECM, for 2RC for example:

$$\begin{matrix}{Z}_{2 RC} = {R}_{o} + \frac{1}{\frac{1}{{R}_{1}} + j {ωC}_{1}} + \frac{1}{\frac{1}{{R}_{2}} + j {ωC}_{2}} \\ = \frac{a ( ω , P )}{c ( ω , P )} + j \frac{a ( ω , P )}{c ( ω , P )} \\ = {Z}_{Re}^{calc} ( ω , P ) + j {Z}_{Im}^{calc} ( ω , P )\end{matrix} \\ were \qquad ( 9 )$$

$$\begin{matrix}a ( ω , P ) = {ω}^{2} [ {ω}^{2} {τ}_{2}^{2} {R}_{o} + {τ}_{1}^{2} ( {R}_{o} + {R}_{2} ) + {τ}_{1}^{2} ( {R}_{o} + {R}_{1} ) + {R}_{o} + {R}_{1} + {R}_{2} ] \\ b ( ω , P ) = - ω [ {τ}_{1} {R}_{1} + {τ}_{2} {R}_{3} + {ω}^{2} {τ}_{1} {τ}_{2} ( {τ}_{1} {R}_{2} + {τ}_{2} {R}_{1} ) ] \\ c ( ω , P ) = 1 + {ω}^{2} ( {ω}^{2} {τ}_{1}^{2} {τ}_{2}^{2} + {τ}_{1}^{2} + {τ}_{2}^{2} )\end{matrix} \} \qquad ( 10 )$$

The previous equations result in a nonlinear cost function which is composed of two independent functions. A solution can take place with gradient-based or derivation-free optimization algorithms. It would be possible to fit several respective transfer functions on models of differing complexity. The accuracy can then be checked and thus the complexity of the ECM, e.g., the number of RC circuits, can be determined by means of the EIS. It has been observed that models with Warburg elements depict the diffusion branch better than pure RC models. However, this can be approximated sufficiently well starting with 2 RC elements for the diffusion. A 3 or 4 RC circuit model represents a good compromise between computing and parameterization complexity and accuracy. In this case, 1 or 2 RC circuits are respectively assigned to the high-frequency dynamic effects, and the diffusion behavior is modeled with 2 RC circuits.

According to the definition of the dynamic model order in block 1042, the static cell behavior is identified and parameterized in block 1043.

Both the relaxation (also called current interruption, CI) and the constant current method (CC) can be used in order to parameterize the static cell behavior for the various cell chemistries. In the relaxation measurement, each cell is discharged and then recharged by defined SOC intervals after a starting capacity determination from the fully charged state. The SOC interval is adapted in the upper, middle, and lower SOC range depending on the increase in the OCV. The capacity is determined with CC-CV charging and discharging according to the specified voltage window of the cells and a respective CV abort criterion of C/50. This capacity value also forms the basis for the SOC-dependent parameterization of the remaining model parameters. After each discharge or charge SOC interval, the cell is relaxed for at least 3 hours (up to 10 hours in the low SOC range), and the voltage value at the end is used as an interpolation node for the discharge or charge curve. The voltage difference between the charge and discharge curves can be interpreted as the maximum value of the hysteresis behavior of the cells.

There is a plurality of approaches in the literature that can be used here to integrate the hysteresis behavior into an ECM. One example is the hysteresis model from Verbrugge et al. in time-discrete form.

The parameterization of the impedance behavior then occurs in block 1044.

Methods in the time and frequency domain can be used for this. The EIS has already been discussed in conjunction with block 1042. This can be used to separately excite and identify different electrochemical reactions due to the alternating current excitation in various frequency domains. The current rate dependency of the charge carrier transfer reaction, however, sometimes cannot be satisfactorily detected with this, because the SOC within the alternating current excitation of a frequency point shifts due to an additionally applied direct-current portion and thus there is no more linear transmission behavior. Therefore, the impedance parameters can be determined based on current pulses (HPPC). A differentiation can be made between two variants in this case:

a) HPPC with pure parameter fitting: In this case, all of the impedance parameters are fitted together or distributed over one or more voltage curves as a result of current pulses. Different electrochemical effects can be considered separately due to this distribution.

b) HPPC fitting with predefined parameters: In contrast to a), individual impedance parameters in this case are predefined for the fitting by upstream measurements, such as Rohm from EIS measurements.

In addition to various C rates, the parameterization of the impedance behavior is carried out for defined SOC and temperature intervals. An optimization algorithm can again be used as described previously for the actual parameter fitting according to variants a) and b).

Finally, the synthesis of the electrical cell model takes place in block 1045 through modeling at the system level.

A global impedance model with open-circuit voltage, hysteresis behavior, ohmic resistance, and up to four RC circuits can be used according to previous blocks 1041-1044 as the electrical cell model. The transmission behavior in the state space representation (as an overview of the 2RC variant) results accordingly as:

$$\text{?} = ( \text{?} ) ( \text{?} ) + ( \text{?} ) \cdot \text{?}$$

$$\text{?} \text{indicates text missing or illegible when filed}$$

All calculations in the cell model are matrix-based, whereby an efficient simulation of connections in series and in parallel is possible.

Obviously, the features of the previously described embodiments and aspects of the invention can be combined with one another. In particular, the features not only can be used in the described combinations but also in other combinations or in isolation without extending beyond the field of the invention.

1. A computer-implemented method for the time-discrete simulation of a battery, wherein the method comprises, in a processor:
applying a thermal model in order to obtain a time-discrete temperature characteristic of the battery,
wherein the thermal model comprises the following:
a thermal cell model for cells of the battery,
an air model for heat exchange between the cells of the battery and ambient air, and
a thermal system model for heat exchange between the cells of the battery and a respective environment,
wherein, when the thermal model is used for a time-step, a cell temperature of the cells of the battery is determined by means of the thermal cell model as a function of an air temperature of the ambient air obtained from the air model in a previous time-step and as a function of an ambient heat flow obtained from the thermal system model in a preceding time-step, and
wherein, when the thermal model is used for the time-step, the air temperature of the ambient air of the air model and the ambient heat flow of the thermal system model are determined as a function of the cell temperature of the cells of the battery.

2. The method according to claim 1, wherein the thermal cell model comprises a heat generation model with an irreversible portion as a function of an electrical cell voltage and a cell current flow of the cells and a reversible portion as a function of a coefficient of entropy, a temperature, and the electrical cell voltage, and
wherein the method further comprises:
implementing a potentiometric measurement to determine the coefficient of entropy of the reversible portion.

3. The method according to claim 2, wherein implementing the potentiometric measurement comprises:
applying a temperature jump at each of a plurality of temperatures, respectively, and
measuring a change in an open-circuit voltage of respective cell.

4. The method according to claim 2, wherein the potentiometric measurement is implemented for a plurality of states of charge of the cells and/or as a function of a charge or discharge direction in order to determine the coefficient of entropy for the several states of charge.

5. The method according to claim 1, wherein the thermal cell model comprises a heat dissipation model for the cells of the battery,
wherein the method further comprises:
determining a spatial domain dimensionality of the heat dissipation model of the thermal cell model by means of simulative or experimental investigation of spatial domain temperature gradients in the cells, and/or as a function of a cell type, and/or as a function of a cooling system of the battery, and/or as a function of a measured operating profile of the cell, and/or as a function of a calorimeter measurement.

6. The method according to claim 5, wherein the heat dissipation model of the thermal cell model is defined analytically for a spatial domain dimensionality of 0D and is defined numerically with finite elements for a spatial domain dimensionality of 1D, 2D, or 3D.

7. The method according to claim 1, wherein the thermal system model comprises one or more of the following variables:
a heat exchange between the cells of the battery as a function of a predefined geometric arrangement of cells with respect to one another,
a heat exchange of the cells of the battery with a solid body cooling element as a function of a predefined geometric arrangement of cells with respect to the solid body cooling element, and/or
a heat exchange of the cells with a fluidic cooling element as a function of a predefined arrangement of cells with respect to the fluidic cooling element.

8. The method according to claim 7, further comprising:
initializing a parameterization of contact resistances and/or thermal capacities of:
the heat exchange between the cells of the battery, the heat exchange of the cells of the battery with the solid body cooling element, and the heat exchange of the cells with the fluidic cooling element, based on predefined reference values, and
implementing a heating measurement of a reference matrix arrangement, with air flowing through of the cells of the battery in order to adapt the parameterization after initialization.

9. The method according to claim 1, further comprising:
implementing a calorimetric measurement to determine a heat capacity of the thermal cell model of the cells.

10. The method according to claim 1, further comprising:
implementing a thermal impedance spectroscopy to determine an anisotropic heat transfer coefficient of the thermal cell model of the cells.

11. The method according to claim 1, further comprising:
using an electrical model to obtain a time-discrete dependency of cell voltage and cell current flow for the cells of the battery,
wherein the electrical model comprises:
an electrical cell model for cells of the battery,
an electrical system model for a current flow between, and
a voltage over cell strings and/or cells of the battery,
wherein the electrical cell model has an electrical equivalent circuit with a series connection of an inductance, of a resistance, and two or more RC circuits,
wherein the electrical cell model further has an ideal voltage source for an open-circuit voltage dependent on the state of charge, and
wherein the cell voltage and the cell current flow are used as an input for a heat generation model of the thermal cell model.

12. The method according to claim 11, further comprising:
implementing an electrochemical impedance spectroscopy measurement to determine the number of two or more RC circuits of the electrical cell model.

13. The method according to claim 11, further comprising:
implementing an electrochemical impedance spectroscopy measurement and/or a current pulse characterization measurement and/or a measurement of a dynamic stress test to determine a parameterization of the equivalent circuit of the electrical cell model.

14. The method according to claim 12,
wherein the electrochemical impedance spectroscopy measurement is implemented in frequency domains which are represented in an operating profile of the battery.

15. The method according to claim 11, further comprising:
implementing a relaxation current measurement and/or a constant current measurement to determine a parameterization of the ideal voltage source.

16. The method according to claim 11,
wherein the ideal voltage source determines the open-circuit voltage with a hysteresis associated with a direction of the current flow.

17. A device comprising at least one processor, wherein the at least one processor is programmed or configured to:
implement a time-discrete simulation of a battery, comprising:
applying a thermal model to obtain a time-discrete temperature characteristic of the battery,
wherein the thermal model comprises the following:
a thermal cell model for cells of the battery,
an air model for heat exchange between the cells of the battery and ambient air, and
a thermal system model for heat exchange between the cells of the battery and a respective environment,
wherein, when the thermal model is used for a time-step, a cell temperature of the cells of the battery is determined by means of the thermal cell model as a function of an air temperature of the ambient air obtained from the air model in a previous time-step and, in addition, as a function of an ambient heat flow obtained from the thermal system model in the preceding time-step, and
wherein, when the thermal model is used for the time-step, the air temperature of the air model and the ambient heat flow of the thermal system model are determined as a function of the cell temperature of the cells.

18. (canceled)
